(19) United States
(12) Patent Application Publication
(10) Pub. No.: US 2003/0146543 A1
(43) Pub. Date: Aug. 7, 2003

(54) Molding method and support system for thermoformable sheet material

(75) Inventors: Gilbert Lebrun, (US); Patrick Gagnon, (US); Younes Youssef, (US)

Correspondence Address: OGILVY RENAULT, 1981 MCGILL COLLEGE AVENUE, SUITE 1600, MONTREAL, QC, H3A2Y3, CA

(73) Assignee: National Research Council of Canada

(21) Appl. No.: 10/346,129

(22) Filed: Jan. 17, 2003

Related U.S. Application Data
(60) Provisional application No. 60/348,639, filed on Jan. 17, 2002.

(51) Int. Cl. B29C 43/02

(52) U.S. Cl. 264/313; 264/322; 264/319; 425/390; 425/398

(57) ABSTRACT

A method and apparatus for molding thermoformable sheet material is set forth. The method includes the steps of providing a conventional stamp type mold, one section of which provides a compliant mold member which is augmented by diaphragm. The diaphragm coacts with the compliant member during a molding phase to ensure dimensional uniformity in the molded article. Further, tight or detailed areas are easily molded by making use of the compliant and diaphragm members. In a further embodiment, tension adjusting is achieved during molding by a series of discrete tension members. The tension members cooperate with the compliant and diaphragm members to significantly improve dimensional uniformity and prevent wrinkling in the molded article.

### CROSS-REFERENCE TO RELATED APPLICATIONS

This application claims the benefit of U.S. Provisional Application No. 60/348,693.

### FIELD OF THE INVENTION

The present invention relates to a method and apparatus for molding thermoformable material sheet, particularly for forming high strength fibre reinforced composite parts, such as composites containing continuous reinforcing filaments. More particularly, the invention relates to a method and apparatus for supporting and tensioning a thermoformable material sheet and to handle this sheet during various phases of a molding process.

### BACKGROUND OF THE INVENTION

Thermoforming/stamping for continuous reinforced thermoplastic composite materials is a process wherein a stack of composite sheets, preheated to the melting temperature of the resin, are installed between two rigid mold sections. The sections define the surface contour of the part being formed and are stamped to the desired shape by closing the mold.

Two main techniques for high volume production of continuous fibre reinforced thermoplastic parts (hereinafter referred to as “CFRTP”) are currently used in the industry. These are the matched-die forming and the rubber-forming techniques. In the matched-die technique, the two mold sections are machined to a desired shape from steel or aluminium. The size of each mold section is such that, once the mold is closed, the gap between the mold section establishes the thickness limit of the finished part thickness to ensure quality. This molding technique allows high volume production of parts and ensures a good surface finish.

One drawback of this technique is the risk of premature solidification and fracture of the laminate during mold closure due to the high thermal conductivity of metallic molds.

A second significant drawback is that friction is induced between the laminate and the mold cavity during mold closure, especially for molds having small draft angles along lateral walls. This friction is mainly explained by the increase of the laminate thickness caused by the reorientation of the fibres along lateral walls of the mold. If improper machining of the mold sections creates cavity thickness distribution in the mold inconsistent with the part, after reorientation of the fibres and redistribution of the material, high-friction zones or, conversely, unpressurized zones are created over the laminate. The laminate friction along lateral walls of the mold significantly increases the tensile in-plane stress and shear deformations in the laminate and increases the risk of fibre breakage, laminate premature solidification (due to intimate thermal contact with the mold over a large surface) and resin percolation. A variation between the thickness of the laminate and that of the cavity, with a laminate locally much thicker than the cavity, can prevent mold closure or locking with subsequent damage.

In addition to the limitations noted previously, another drawback of the matched-die technique is the presence of variable consolidation pressures over the part area during mold closure. This is pronounced over the sides of deep parts having low draft angles for which the consolidation pressure is a small fraction of the total mold closing load. The matched-die forming technique necessitates machining of a male section such that the mold cavity has a variable thickness that matches closely the final thickness distribution of the part after molding. Such thickness must be precisely predicted prior to mold fabrication, using modelling computer programs, to avoid unconsolidated or poorly consolidated regions over the part area. These procedures increase the design labour and time and the manufacturing costs.

In respect of the rubber-forming technique this is similar to the matched-die technique. In this methodology, the male section of the mold is made of, for example, rubber and molded to the desired part geometry. The advantages of using a rubber punch are that during mold closure the rubber deformation allows the application of a quasi-hydrostatic pressure over the part area. This ensures improved conformation of the laminate to the mold geometry compared to the matched-die process and permits more flexibility in the punch design. Further, lower thermal conductivity of the rubber punch reduces the cooling rate of the laminate, allowing more time to mold the part before premature solidification arises. However, compared to the matched-die technique, some drawbacks are encountered, such as:

A molded part having a good surface finish on one side only (the rubber punch being easily indented by the fibres of the laminate, inducing a rough surface finish);

An increased risk to induce friction between the laminate and the mold cavity during mold closure owing to the increased size of the rubber punch under deformation. Indeed, the membrane stress applied on the laminate by the supporting system is transferred to the punch which, in the case of a soft rubber punch, will deforms and expands laterally. In such a case, premature laminate solidification and part defects can be induced during mold closure due to the increase of the laminate friction over the side walls of the mold cavity, similar to the case explained above in relation with the matched-die forming process and the prior art;

The locking of the mold closure (known as “barrelling”) induced by an excessive lateral expansion of the punch is such that it becomes impossible to completely close the mold;

The punch can collapse (or locally buckle) under compression loads induced during mold closure for part geometries having large depth to width (or length) ratios. Such behaviour can be observed for the whole punch or over local regions of the part for which the depth to width ratio promote local buckling of the punch;

An increased risk to obtain part distortions after molding due to the unbalance of part cooling on the punch side as compared to the cavity side (rubber having a much lower thermal conductivity than metals);

The machining of two mold cavities is necessary, one corresponding to the mold cavity and the other one used to mold the rubber punch. This increase the fabrication time and the overall manufacturing costs;

The rubber behaviour under deformation has to be well known in order to insure a good part quality. Indeed, a good conformation of the laminate in the corners and the reduced risk to induce the “barrelling” and mold locking effects are usually achieved with hard rubbers while a quasi-hydrostatic pressure applied over the part area for consolidation is insured when soft rubber are used.

Moreover, the high thermal expansion property of elastomer is such, that the thermal expansion of the punch under the effect of heat can easily overpass the volume of the mold cavity, especially for large molds. This must be accounted for in the mold design, increasing the design difficulties and delay.

Many other techniques have been developed to mold CFRTP parts using rubber membranes assisted by a vacuum and/or air pressure to conform the laminate to the mold geometry. Some examples of these techniques include thermoforming, as illustrated in patent publication number FR-2696677-A1, double-diaphragm thermoforming technique, as illustrated in patent publication number EP-0410599-A2, and a thermoforming technique using four diaphragms, as illustrated in Australian patent number 738958, wherein one pair on each side of the part with hot oil flowing inside each pair of diaphragm to reduce the cooling rate of the laminate. The main drawback of these techniques is their low volume capability of parts molding, due to the high labour needed to prepare to mold prior to molding and to the low cycle life of rubber membranes submitted to large deformations, wear friction and large temperatures. Finally, a general stamping technique for shaping synthetic materials, using a male and female mold sections made of rigid backing members mounted by facing units and defining the contours of the mold cavity. Again, similar to the matched-die and the rubber-forming processes described above, the risks of laminate friction along lateral walls of the mold are present, especially for parts having small draft angles.

No documented techniques have been developed to support, apply tension loads and follow the movements of the laminate in the thermoforming/stamping process for CFRTP parts. For small parts, a blank holder similar to what is used in the stamping process of steel sheet, can be used to induce membrane stresses in the laminate during mold closure. However, the system does not provide adequate control of membrane tension and renders impossible the application of different loads at different locations about the periphery of the laminate. Moreover, if the holder is made of a flat steel ring compressing the laminate over the flat region of the mold cavity, it can create premature cooling of the thermoplastic matrix due to heat removed by conduction. This has an affect on the quality of the molded part.

### SUMMARY OF THE INVENTION

The present invention addresses the foregoing problems of the prior art and is mainly directed to providing an improved method and apparatus for molding parts made of thermoformable sheet material, such as CFRTP composite materials.

According to a first object of an embodiment of the invention, this is provided a method of molding a thermoformable sheet material having opposed sides, comprising:

providing a mold having a first section and a second section, the first section including a compliant mold member, the second section including a rigid mold base configured to releasably receive the first section;

providing a selectively pressurizable diaphragm in the first section for coaction with the compliant mold member;

positioning the sheet material between the first section and the second section and closing the mold; and

pressurizing the diaphragm to urge the compliant member against the sheet to mold the sheet into a shape of the second section.

As a first variation, the invention is a molding technique for thermoformable sheet comprising a female section having a mold cavity to shape one side of the sheet, a male section having a rigid base plate to stamp at least a portion of the second side of the sheet, and one or more inflatable elastomeric diaphragms to shape other portions of the second side of the sheet.

A further object of one embodiment of the present invention is to provide a method of molding a thermoformable sheet material having opposed sides, comprising:

providing a mold having a first section and a second section, the first section including a compliant mold member, the second section including a rigid mold base configured to releasably receive the first section;

providing a selectively pressurizable diaphragm in the first section for coaction with the compliant mold member;

positioning the sheet material between the first section and the second section and closing the mold;

adjusting sheet material tension during molding to prevent inconsistencies in the molded sheet; and

pressurizing the diaphragm to urge the compliant member against the sheet to mold the sheet into a shape of the second section.

It is sometimes necessary to have the elastomeric diaphragm on the female section of the mold, depending on which side of the part a good surface finish is desired. In this second variation, the invention is a molding technique for thermoformable sheet comprising a male section having a punch block to shape one side of the sheet, a female section having a bottom cavity plate to stamp at least a portion of the second side of the sheet, and one or more inflatable elastomeric diaphragms to shape other portions of the second side of the sheet.

The molding method of the present invention comprises the steps of stamping at least a portion of the sheet with a rigid plate, and shaping other portions of the sheet with one or more inflatable elastomeric diaphragms. The diaphragm(s) may comprise multiple layers (plies) of the same or different materials. This has an advantage of enhancing strength and durability of the diaphragm under prolonged use. Further, the diaphragm may be reinforced or otherwise strengthened.

The resulting product is a part having a good finish on the side formed by the rigid mold and where the rigid base plate punches on the other side of the part. The remaining portions of the part have a rougher finish left by the inflatable elastomeric diaphram(s). This leaves a clear transition line between the surfaces created by the punch and the inflatable elastomeric diaphram(s), which is characteristic of the present method.

This invention also relates to a handling and support system for the laminate, especially for the transfer of the laminate from the oven to a mold. This system also applies a membrane tension over the laminate during the action phase of the molding process. This handling and support system for sheet material to be shaped comprises a plurality of clamping supports distributed at the periphery of a support frame with a jaw at one end of each clamping support to retain the sheet material; the clamping supports are mounted to permit rotation and translation of the jaw to follow the sheet material movements. The clamping support for sheet material to be shaped comprises a jaw at one end to retain the sheet material, a body mounted on a joint allowing rotation on at least two axis and having a translation system permitting controlled translation movements of the sheet.

A still further object of one embodiment of the present invention is to provide a method of molding a thermoformable sheet material having opposed sides, comprising:

providing a mold having a first section and a second section, the first section including a compliant mold member and a selectively pressurizable diaphragm, the second section including a rigid mold base configured to releasably receive the first section;

positioning the thermoformable sheet material between the first section and the second section;

stamping the first section into the second section;

compressing, by pressurization of the diaphragm, the compliant member to urge the sheet material against the rigid mold base whereby the sheet material is uniformly dimensioned throughout its molded shape; and

depressurizing the mold to release the molded shape.

During the formation phase (mold closure), the clamping supports control the movement of the fibres in the laminate by applying the desired membrane forces on the laminate. This support system follows the sheet translations along the X-Y-Z axes, and allows rotations around the Y and Z axes. This freedom of movement is necessary to follow the movements of the composite sheet, while maintaining a membrane force on it to avoid wrinkles formation during forming. This support system is also easy to install and remove from the mounting steel frame. This system also precludes the sagging of the sheet during heating because of the presence of tensioning means, which acts on the sheet with a load much larger than the load generated by the weight of the sheet.

By the provisions noted above, it is possible to mold complex forms while ensuring a quality result.

A further object of one embodiment of the present invention is to provide a method of supporting and adjusting the movement of sheet material during a sheet molding operation, comprising:

providing sheet material to be molded;

providing a frame having a plurality of selectively movable clamp members;

clamping the sheet material with the clamp member;

effecting a molding operation during which the sheet material is exposed to irregular forces; and

selectively operating the clamping members to allow movement and adjustment of the sheet material during exposure to the forces.

A still further another object of one embodiment of the present invention is to provide an apparatus for supporting and adjusting the movement of sheet material during a sheet molding operation, comprising:

a frame

a plurality of selectively movable clamp means for clamping the sheet material;

means for effecting translational movement of the clamping members relative to the frame for adjustment of the sheet material relative to the frame during exposure to forces encountered in the molding operation; and

means for effecting rotational movement of the clamping members about a vertical and a horizontal axis relative to the frame, whereby the sheet material is dynamically adjusted in a plurality of directions during molding.

Yet another object of one embodiment of the present, invention is to provide an apparatus for molding a thermoformable sheet material having opposed sides, comprising:

a mold having a first section and a second section, the first section including a compliant mold member, the second section including a rigid mold base configured to releasably receive the first section, the first section and the second section forming a mold volume when in contact;

a selectively pressurizable diaphragm in the first section for coaction with the compliant mold member and operable within the mold volume; and

means for pressurizing the mold volume to move the diaphragm whereby the sheet material is uniformly dimensioned throughout its molded shape.

Having thus generally described the invention, reference will now be made to the accompanying drawings.

### BRIEF DESCRIPTION OF THE DRAWINGS

FIG. 1a is an enlargement of a portion of the cooperating mold sections to illustrate the stretch and premature compression of laminate of prior art;

FIG. 1b is an enlargement of a portion of the mold sections to illustrate shearing distances for small draft angle during the matched-die forming process of the prior art;

FIG. 2 is a side view of a cross section of both parts of the mold of the present invention with the elastomeric diaphragm installed on the male section of the mold;

FIG. 3 is a side view of a cross section of a second embodiment of the invention with the diaphragm installed on the female section of the mold;

FIG. 4 is a side view of a detail of a cross section of a part made from the mold of FIG. 2;

FIG. 5 is a top view of the sheet handling system over the female section of the mold;

FIG. 6 is a side view of the clamping support having the jaw closed and the telescopic tubes extended;

FIG. 7 is a side view of the clamping support having the jaw opened and the telescopic tubes retracted and body partially cut away; and

FIG. 8 is a side view of an alternative version of the clamping support having the jaw in an intermediate position and the telescopic tubes retracted.

Similar numerals denote similar elements.

### DETAILED DESCRIPTION OF THE PREFERRED EMBODIMENT

The method of the present invention will now be described in detail while referring to the accompanying drawings.

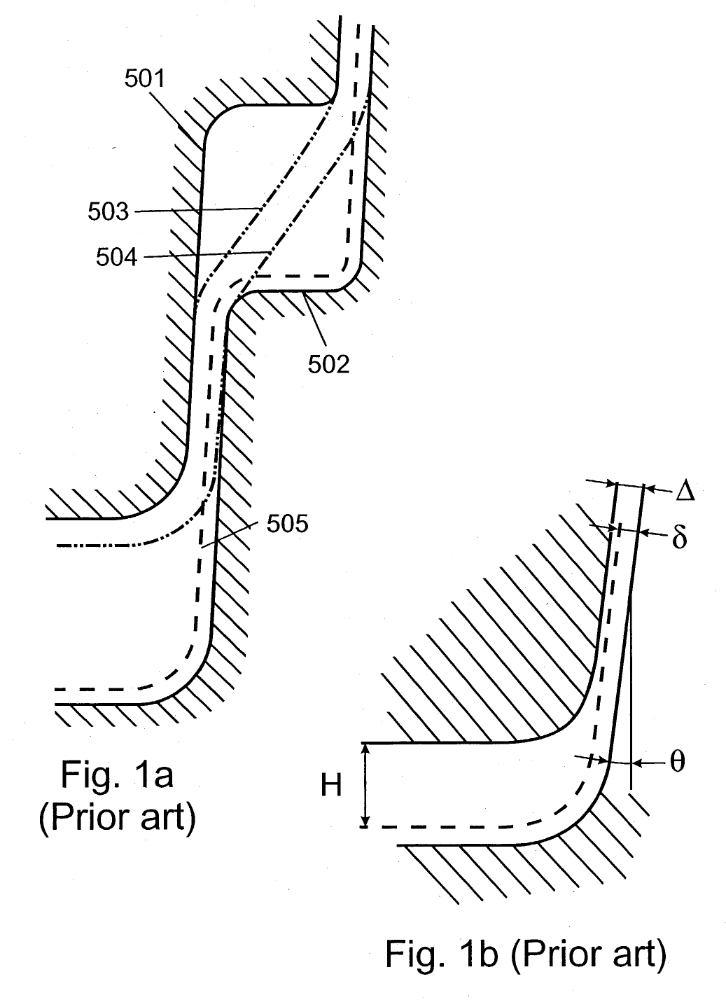

Referring initially to the prior art, FIGS. 1a and 1b, an example of a small draft angle is depicted to explain how these difficulties appear when using the matched-die process. The wall of the male section is illustrated by line 501, the wall of the female section is illustrated by line 502, the predicted thickness of the laminate after being shaped is illustrated by dotted line 505, and the profile of the laminate before being shaped (or during shaping, with the corresponding increase of the laminate thickness caused by the re-orientation of the fibres) is illustrated by phantom lines 503 and 504. It is clear from FIG. 1a that the wall 502 of the female section touches the laminate 503-504 before the mold is fully closed. Some friction occurs from this original contact to the fully closed position. Indeed, FIG. 1b shows how the draft angle influences the distance a laminate, thickened under the effect of intra-ply shear deformations, have to shear between both sections of the mold to ensure the mold to fully close before the solidification of the laminate. The distance between the original contact between the male section and the laminate is expressed as the distance H. Each section of the mold has an inward angle converging toward the bottom of the female section, this angle θ is expressed relatively to the translation axis of the male section. Then the laminate thickness before the mold is fully closed is expressed as the distance Δ, and the thickness predicted after shaping is expressed as the distance δ. The distance H depends on the draft angle θ, the thickness of the laminate prior the start of friction Δ and the thickness of the part δ and follow the relation H=(Δ−δ)/sin θ. For example, a mold having a draft angle of 3°, a thickness after intra-ply shear of 7 mm and a final part thickness of 4 mm will shear under friction between the two mold walls over a distance of 57.3 mm. Over such a distance, the risks to damage the fibres and the surface finish of the product, to induce resin percolation at the bottom corner of the punch or to solidify prematurely are important.

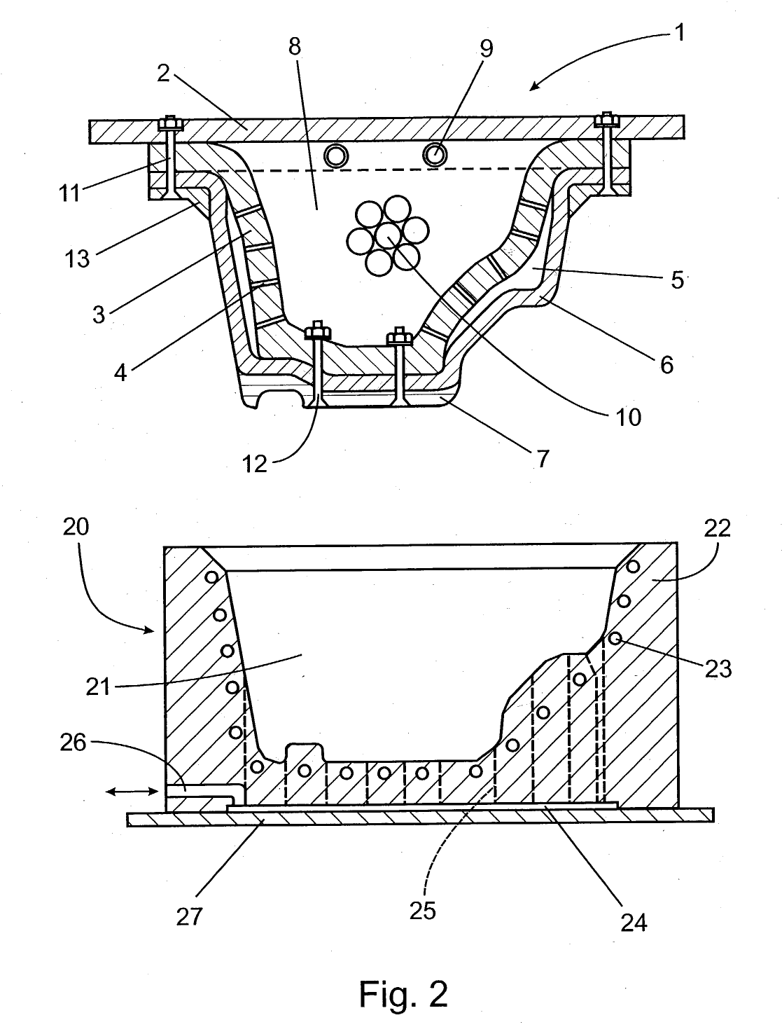

Referring to FIG. 2, both cooperating sections of the mold are shown, namely, the male section 1 or punch, and the female section 20 or cavity. Section 1 has a rigid support 2 to hold the rigid sub-structure 3 and an elastomeric diaphragm 6 using a holding plate 13 retained by fasteners such as nuts and bolts 11 or by proper adhesive. A rigid base plate 7 matching the geometry of the bottom of the female section is fastened to the rigid sub-structure 3 with, for example, nuts and bolts 12. The elastomeric diaphragm 6 is held firmly sandwiched between the matching surfaces of base plate 7 and sub-structure 3. The portion of the elastomeric diaphragm 6 between the holding plate 13 and the rigid base plate 7 has walls slightly longer than the corresponding walls of the rigid sub-structure 3 (the side walls of the rigid sub-structure are slightly recessed toward the interior of the punch) to form a gap 5 between the rigid sub-structure 3 and the flexible elastomeric diaphragm 6. A vacuum zone 8 is formed by the assembly of inner surfaces of the rigid sub-structure 3 and of the rigid support 2. Air or any other suitable gas is blown or aspirated through the vacuum zone 8 using one or more tubes 9. Inside the vacuum zone, a filler material 10, made for example of blocks or spheres, reduces the volume of air needed to fill the vacuum zone 8 (or to create the vacuum in the vacuum zone 8), thus improving the reaction time of the elastomeric diaphragm. Holes 4 are drilled in the side walls of the sub-structure 3 to allow injection (or extraction) of air, from (or to) the vacuum zone 8, in the gap 5 in order to pressurize (or retract) the diaphragm 6 over (from) the composite laminate.

The female section of the mold 20 comprises a cavity block 22 having a mold cavity 21 and a network of tubes 23 for temperature control of the mold in operation. A rigid support plate 27 holds the cavity block 22. A vacuum zone 24 is formed by the cooperation of the walls of a recess, at the base of the cavity block 22, and the top wall of the rigid support plate 27. Drilled channels 25 provide communication between the mold cavity 21 and the vacuum zone 24, from where air can freely circulate to or from an inlet/outlet port 26. This provides a free flow of air through out of the cavity block 22 when the male section 1 moves toward the female section 20 and air entrapped between the laminate and cavity 21 has difficulty to escape when sections 1, 20 are partially or fully closed. This also assists the laminate to conform completely to the small radius edges of the part that could be difficult to reach by the diaphragm 6.

In operation, a CFRTP laminate preheated to the melt temperature of the thermoplastic matrix, is first loaded between the male and female sections of the open mold. A clamping system (described herein after) installed at the periphery of the laminate supports the laminate, follows the fibre movements and applies a pre-determined tension on the laminate during the forming process. The laminate is considered undeformable along the direction of the fibres, so the periphery of the laminate has to move to allow mold closure. The formation process using this invention follows three major steps after the preheated laminate has been pre-positioned between the male and female sections of the open mold.

In a first step, prior to mold closure, an air vacuum is applied in vacuum zone 8 via the air inlet/outlet port 9. Air flowing through the highly porous media 10 and through the holes 4, forces the elastomeric diaphragm 6 to move against the outside surface of the sub-structure 3, increasing the space available for laminate movements along lateral walls of the mold, between the elastomeric diaphragm 6 and the vertical surface of the cavity 21 during closure.

In the second step, the vacuum in the vacuum zone 8 is maintained until a portion of the piece (usually at the bottom) to be shaped has been fully drawn by the bottom base plate 7. The second step is completed when this portion of the piece is formed.

In the third step, the vacuum in the vacuum zone 8 is rapidly replaced by air or any suitable gas pressure, which flow through the media 10 and through the holes 4, to make the elastomeric diaphragm 6 having a geometry matching the geometry of the mold cavity 21 to move towards the laminate and to achieve the formation phase by applying a pressure over the laminate via the diaphragm 6 and the inside wall of the cavity 21. During this step, a vacuum can be created between the laminate and the mold cavity 21, via the vacuum zone 24 and the drilled holes 25, to facilitate the conformation of the laminate to the exact shape of the cavity 21. The last step is to open the mold by applying first a vacuum in the vacuum zone 8 to pull back the elastomeric diaphragm 6 close to the sub-structure 3, and to provide an easier removal of the freshly molded part. The diaphragm 6 can be “pre-molded” to conform closely the geometry of the part, to shape the laminate during mold closure, while still keeping the necessary space to allow free movement and free deformations of the laminate along the side walls of the mold. Moreover, the hardness of the elastomeric materials used to produce the diaphragm 6 can be modified to improve the conformation of the laminate. For example, small radius edges of the diaphragm could be made harder to push the laminate into place, while the flat walls of the diaphragm 6 could be kept soft enough to allow the large deformations needed to obtain a uniform consolidation pressure over the part surface. The last step is to remove the part from the mold (de-molding). This step can be eased by applying air pressure (or any suitable fluid or gas) in room 24 and holes 25 to push air between the part and the surface of the cavity 21.

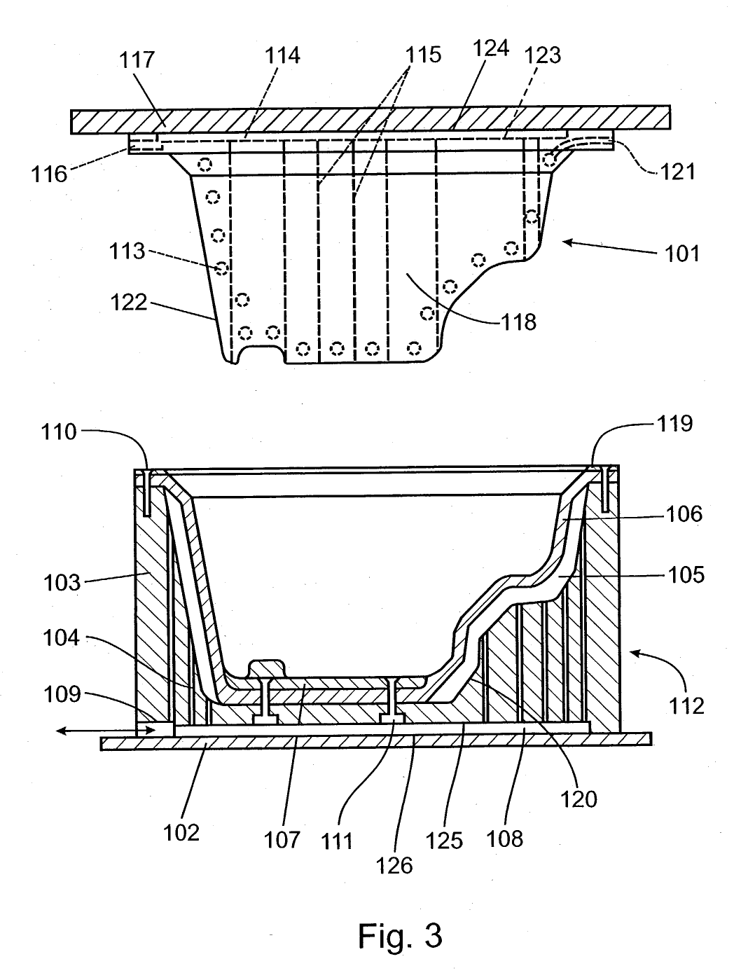

Referring to FIG. 3 a second embodiment of the invention is shown where the membrane is located in the female section of the mold, for product needing a good surface finish inside.

The male section 101 or punch has a rigid support 117 to hold a punch block 118 having a network of tubes 113 for temperature control of the mold in operation. A vacuum zone 114 is formed by the cooperation of the walls of a recess 123, at the top of the punch block 118, and the bottom wall 124 of the rigid support 117. Drilled channels 115 provide communication between the bottom of the punch block 118 and the vacuum zone 114. From an air inlet/outlet port 116, air or any suitable gas vacuum/pressure can be applied through the drilled channels 115 to the external surface 122 of the punch block 118.

The female section 112 has a rigid support plate 102 to hold the cavity block 103. A bottom vacuum zone 108 is formed by the cooperation of the walls of a recess 125, at the bottom of the cavity block 103, and the top wall 126 of the rigid support plate 102. A bottom cavity plate 107 is fastened to the cavity block 103 by, for example, nut and screw 111. A portion of diaphragm 106 is held firmly sandwiched between the cooperating surfaces of plate 107 and block 103. Rigid top plate 119 retains the periphery of diaphragm 106 to the top periphery of block 103 using suitable fasteners, 110. Air holes 104 drilled through the cavity block 103 provide communication between the gap 105 and zone 108. The portions of diaphragm 106 between the rigid top plate 119 and the bottom cavity plate 107 can be inflated or deflated in the space corresponding to the gap 105. This can be done from an inlet/outlet port 109 through the intermediary of the air holes 104 to allow free movement of the melted composite laminate along the side wall of the cavity formed by surface 122 and the inner surface of the elastomeric diaphragm 106.

In operation, a preheated CFRTP laminate to the melt temperature of the thermoplastic matrix, is first loaded between the male and female sections of the open mold. A clamping system (described later) installed at the periphery of the laminate is used to support the laminate and is designed such as to follow movement during the forming process (the laminate being considered undeformable along the fibres directions, the periphery of the laminate must be free to move to allow mold closure). The forming process using this invention follows three major steps after the preheated laminate has been pre-positioned between the male and female sections of the open mold.

In the first step, prior to the mold closure, an air vacuum is applied in the vacuum zone 108 via air inlet/outlet port 109. Air flowing through holes 104, forces elastomeric diaphragm 106 to move against the surface 120 of the cavity block 103. This increases the space available for laminate movement along side walls of the mold, between the elastomeric diaphragm 106 and surface 122 of punch block 118 during closure.

In the second step, the vacuum in zone 108 is maintained until a portion of the part (usually at the bottom) to be shaped has been fully drawn by the bottom cavity plate 107. The second step is completed when this portion of the piece is formed. In this second step, the laminate is free to move along the lateral walls of the mold (similar to the discussion of FIG. 2) to preclude premature cooling of the laminate on the relatively cooler punch block 118, excessive friction between the moving laminate and the side walls of the mold, and to ease re-orientation of the fibres in the laminate by the clamping system (discussed later). This prevents wrinkle formation in the molded part.

In the third step, the vacuum in zone 108 is rapidly replaced by air or any suitable gas pressure, through holes 104. This makes diaphragm 106 move toward the laminate. To complete the forming phase, pressure is applied over the laminate via the elastomeric diaphragm 106 and the surface 122 of the punch block 118. This third step allows the final consolidation of the part which is greatly improved and standardized by the use of the flexible elastomeric diaphragm 106 compared to the matched-die forming process. To improve conformation and consolidation of small radius re-entrant edges of the part, a vacuum can be induced between the laminate and the punch surface 122 via holes 115 and vacuum zone 114. Once the part is molded, an air vacuum is created in the room 105 to retract the diaphragm 106 and ease the opening of the mold. This also protects the diaphragm from being damaged by the upward movement of the punch. Once the mold is opened, an air pressure can be applied in room 114 and holes 115 to assist de-molding (removal) the part from the punch block 118.

Referring to FIGS. 2 and 3, this present invention combines characteristics of matched-die, rubber forming, thermoforming and diaphragm forming processes. Indeed, the rigid sub-structure 3 or inner cavity surface 120 maintain a geometry substantially similar to the part and combined with the rigid base plate 7 or bottom cavity plate 107, allow the fast stamping of the bottom region of the piece (necessary for high volumes manufacture of pieces). The flexible elastomeric diaphragm 6 or 106, molded to the exact shape (or close to) of the part, allows the formation and consolidation of small geometric features like small radius corners, by allowing the application of a quasi-hydrostatic pressure in these regions (via the use of a flexible elastomeric diaphragm). Depending on the choice made for the diaphragm thickness, combined with a good choice of elastomer hardness, the deformations imposed to the elastomeric material in these regions can make the forming of small features to be similar to what is observed in the rubber-forming process, that is, a uniform pressure applied over the region owing to the quasi-hydrostatic nature of the pressure induced when rubber is under deformation in a confined region of the mold. Finally, during the forming stage, a vacuum can be applied in the sharp corners of the part (via a vacuum applied through the drilled holes 25 or 115) to assist the forming of these regions. This is similar to the thermoforming process of a thermoplastic sheet, and the use of a diaphragm having a thickness, strength and hardness adjusted to the piece needs make the invention slightly similar to the thermoforming and diaphragm forming processes. Eventually, the flexible elastomeric diaphragm 6 or 106 can be made of any kind of elastomeric materials, reinforced or not. Indeed, by pre-shaping the diaphragm to the final geometry of the part (or close to), the presence of reinforcement inside the diaphragm will not prevent the free movements of the diaphragm in the gap 5 or 105 because these movements are in the out of plane direction with respect to the plane of the diaphragm. Any reinforcement, like continuous fibres for example, laminated inside the diaphragm will mainly reduce in-plane deformations of the diaphragm, but not the out of plane deformations and movements, needed for the forming of the part.

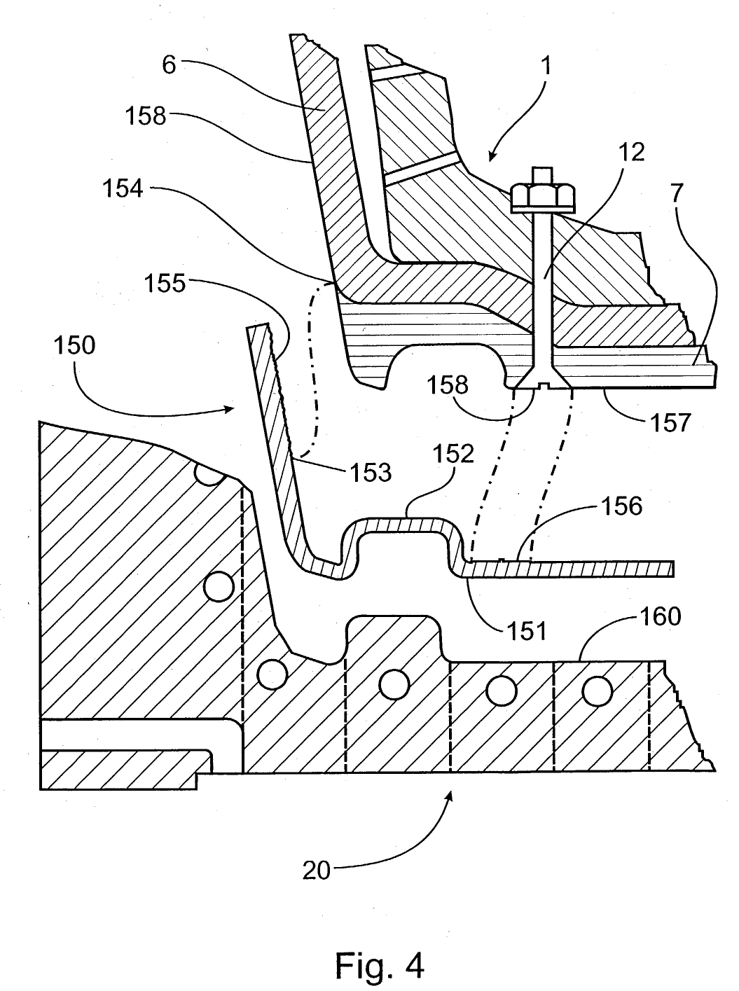

FIG. 4 illustrates a detail of a part shaped according to the present invention with a mold similar to FIG. 2. The part 150 has an external wall 151 with a good surface finish obtained from the conformation to the rigid wall 160 of the female section of the mold 20. The internal wall 152, 155 has a good surface finish in a first portion 152 corresponding to the external wall 157 of the punch 7, and a rougher surface finish in a second portion 155, corresponding to the external wall 158 of the flexible elastomer diaphragm 6. The seam 154 between the punch 7 and the flexible elastomer diaphragm 6 leaves a clear mark 153 between the first portion 152 and the second portion 154. These portions 152, 154 and mark 153 are indications that this product has been made from the apparatus and method according to the present invention.

In the example illustrated in FIG. 4, all the exterior walls 151 of the part have good surface finish. Bottom section 152 of the internal wall of the part, obtained by the stamping action of the stamping plate 7 also has a good surface finish. The good surface finish of the internal wall of the part can be located as needed by changing the location of the stamping plate 157. Preferably, the stamping plate 157 is located in order to pull the sheet inside the female section of the mold 20 to cause limited displacement (inflation) of the flexible elastomer diaphragm 6. When nuts and bolts 12 are used to fasten the stamping plate 7 and the flexible elastomer diaphragm 6 to the rigid sub-structure 3, the presence of the fastener head 158 at the surface of the stamping plate 157 is another distinctive mark left on a product obtained by the apparatus and method of the present invention. The good surface finish is inverted when the product is obtained using the apparatus illustrated on FIG. 3. In this situation all the internal walls of the part have good surface finish and a section of the external walls obtained by the stamping action of the stamping plate has a good surface finish. The mark by the fastener is then on this external wall portion of the part.

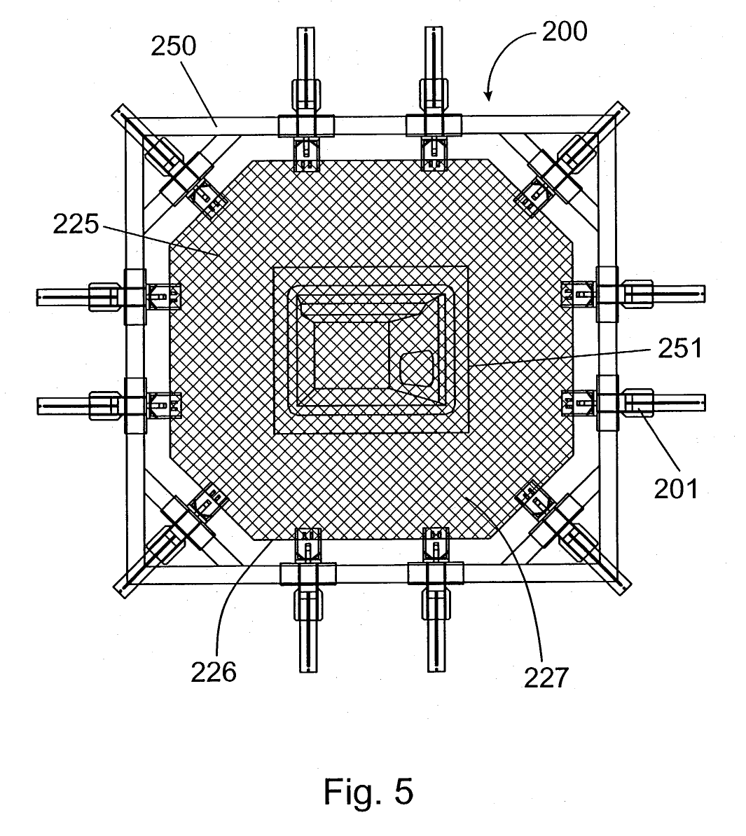

FIG. 5 shows an overall view of the mold 251, the composite laminate 227 and the laminate clamping system composed of the clamping supports and the support frame. Referring to FIG. 5, a support system 200 comprises a support frame 250 and a set of clamping support 201. Each individual clamping support 201 follows the movements of the laminate periphery 226 during the molding phase, and these movements depend on the geometry of the mold. Indeed, the translation and rotation of each support depends on the movements of the laminate fibres 227 (oriented at pre-defined angles), which are subject to the mold 251 geometry.

To optimize sheet size and permit molding of large parts while minimizing material loss, the space occupied by the clamping system inside the press support frame and the clamping surface (the laminate surface inside the clamps) must be minimized. The supports must be able to sustain the high temperatures of the oven. The tension forces induced on the laminate by the clamping supports have to be adjustable to the desired intensity to allow proper re-orientation of the fibres in the laminate during molding to avoid wrinkles formation in the part. Also, because wrinkle formation depends on part configuration, the force needed from each support may be different. In other words, the membrane forces can be adjustable on each support, and these forces can be different from support to support depending on the mold geometry.

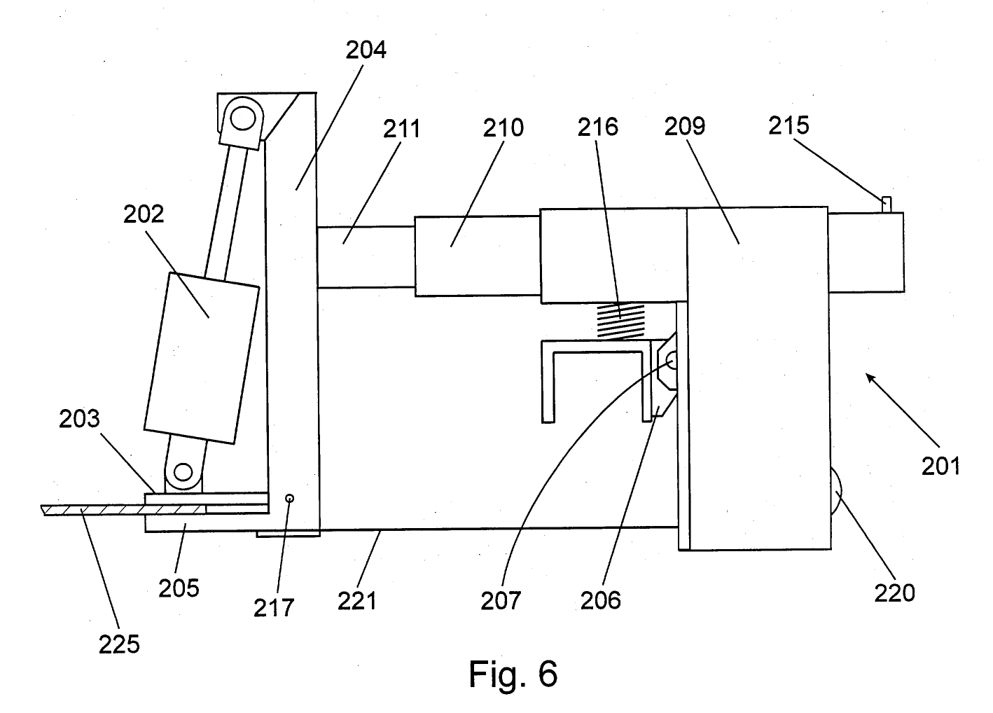

Referring to FIG. 6, a clamping support 201 has an inverted L-shaped body 209 having a horizontal top portion made of a tube section, shown in the example as a rectangular tube section; a vertical section made of a least one plate is also included. A plurality of telescoping tubes, 210 and 211, are inserted in the tube section of the body 209, to form a telescopic translation system.

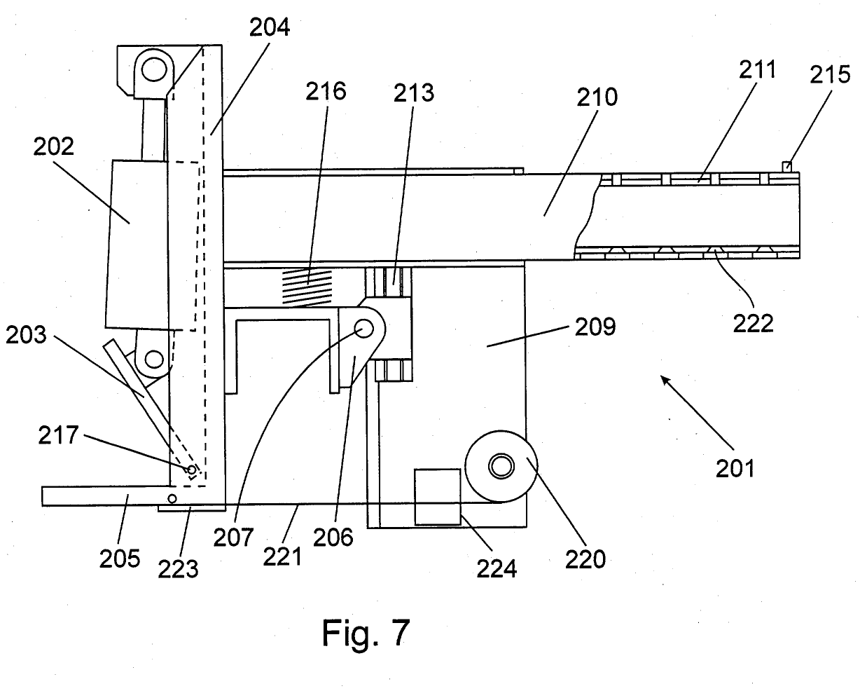

A bracket 206 attaches the clamping support 201 to the press support frame 250. The bracket 206 is joined to the body 209 by an universal joint 207 and 213 (FIG. 7), having pivot 213 (shown in the cut on FIG. 7) to provide rotation about a vertical axis or Y-axis, and a second pivot axis parallel to the portion of the support frame 250 over which bracket 206 is attached, perpendicular to the first axis.

A stabilizing compression spring 216, acts as suspension to stabilize the support 201 during the forming step and when no external force is applied to the support. Spring 216 stabilizes support 201 movement around the Z-axis against abrupt changes. The compression spring 216 also precludes premature cooling of the sheet over the top flat region around the aluminium cavity. This is achieved by keeping the sheet upward the portion of the laminate outside the mold during molding, while still allowing rotation of the support around the Z and Y-axis by sliding over the mounting bracket 206. The compression spring 216 is attached at its top portion to the body 209, and the bottom portion slides freely over the bracket to allow the Y-axis rotations around the pivot 213.

A jaw system of the support 201 comprises a jaw assembly 202-205 having at the bottom a fixed jaw portion 205. The system provides a vertical frame portion 204 having attached them to the frame portion 204 is fixed to tube 211. The fixed jaw portion 205 cooperates with a pivoting jaw 203 to retain a peripheral portion of a laminate 225. The pneumatic piston 202 and the pivoting jaw 203 allows composite sheet loading on the supports. The rotation of these components about their respective pivot, increases the clearance necessary to easily install the sheet from the top of the supports, with the open version depicted in FIG. 7.

Cylinder 202 and the jaw assembly 205 are movable in the X direction via tubes 210-211. Tube 211 is fixed at one end to the jaw assembly 204-205 and is slidable inside tube 210, which in turn is slidable in the tube portion of body 209. During formation, support 201 follows the laminate translation along the X-axis via the tubes 210-211 sliding one into the other and into the tube section of the body 209.

A tensioning system 220-221 includes a cable 221 and a winding device 220. A braking system 224 is provided to control abrupt changes in tension or to increase tension. In FIGS. 6 and 7, the tensioning system shown is a constant force spring made of a flat steel strip enrolled on itself and commercially available under different sizes and forces. Tensioning springs inside the winding device 220 provide application of a constant force during the formation phase and during the return of the support to its initial position. These actions are conducted without any external control, except for the action of the pneumatic piston 202. This makes the system work very efficiently and easily, even at high oven temperatures. The tensioning springs 220-221 can be interchanged or combined with springs of different forces, on the same support or on different supports distributed around the composite sheet to allow adjustment of the membrane tension over the composite sheet necessary to insure a good conformation during the forming phase. This means that the supports located along the sides of the composite sheet can be mounted with different tension springs. In the event that larger membrane forces are needed to stretch the composite sheet or if smooth variations of the loads are needed during supports translations along the X-axis, braking system 224 installed between the plates of the body 209 in front of the spring and on each side of the strip can be designed and installed on the support. Such a system could be externally controlled by a computer (not shown) or made simple via the use of friction pads mounted with adjustable compression springs.

A locking conical head screw (not shown) installed in one of the holes 222 facilitates limited translation movements along the X-axis. This type of stop avoids damage to the mold and supports during mold closure. The provision of several holes permits adjustment of translation distance.

Referring back to FIG. 6, in operation, the first step is to clamp the laminate to a set of supports 201. To clamp the laminate, the pneumatic cylinder 202 activates the jaw 203 rotating around a pivot point 217 located at the base of the jaw-assembly. When all supports are closed, the whole clamping system and the laminate are moved inside an oven (not shown) for the heating of the laminate and the melting of the thermoplastic matrix of the laminate.

The second step is to preheat the laminate to the desired temperature in the oven, and then position the preheated laminate over the mold, ready for forming. The third step is the formation process, which may be a known formation technique or the formation technique developed in the present invention. During the formation step, supports 201 follow the laminate using the tubes 210 and 211 for translation movements and the universal joint 207 and 213 for rotation movement. The support system 200 also maintains a pre-determined tension on the laminate, using the tension springs 220 and 221. Once the part is formed, the mold is re-opened. At this point, the tension from the support system 200 assists the de-molding or removal step and the molded part is discharged from the mold. As soon as the part is unclamped, tension springs 220 and 221 of each clamping support 201 force the sliding tubes 210 and 211, to retract into one another and into body 209. This places the clamps near the sides of the press frame, ready to begin another molding cycle.

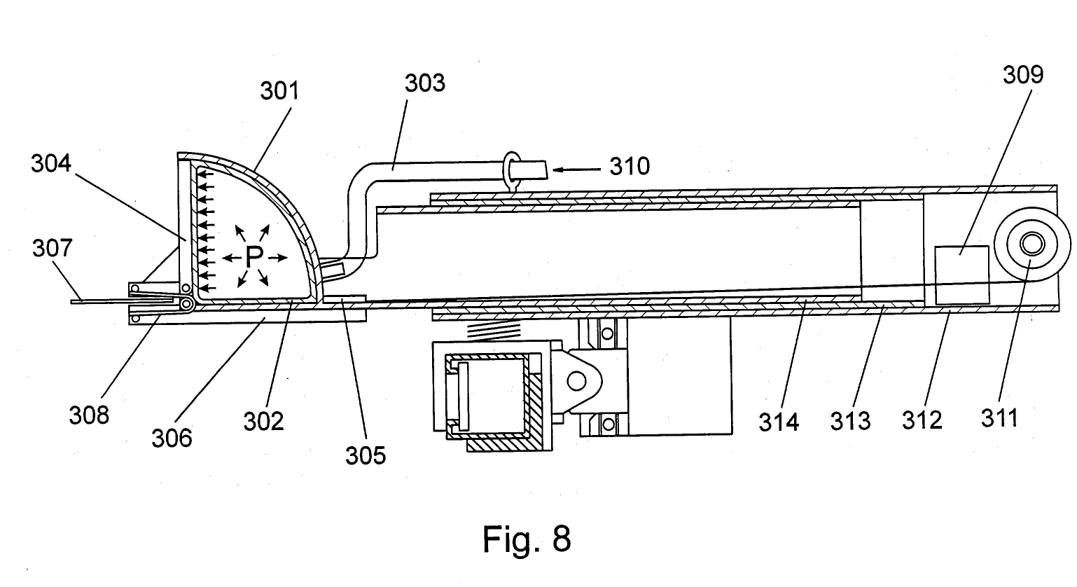

Referring to FIG. 8, an alternative solution of the support can be used when there is a concern about an obstruction caused by the jaw assembly 202-205. This is particularly important to reduce the obstruction when the press frame moves from the oven to the top of the mold with the inherent risk of collision with adjacent equipment. It is also possible, with this system, to minimize the space occupied by the jaw-assembly 202-205 of the preceding support system inside the press-support frame 250 and thus maximize the size of the part that can be molded. The system is based on the use of the same kind of constant force springs to apply the membrane force on the composite sheet but with a much smaller clamping device.

The clamping device has an L-shaped clamp 304 rotating around a pivot point located at the corner of the L shape and inside a quarter-cylinder metallic enclosure 301. Inside the enclosure 301, an inflatable diaphragm 302 mounted with an inlet valve at the rear of the enclosure 301 is installed with an air inlet tubing 303 allowing the diaphragm to inflate under pressure and deflate under vacuum. The extremity of the strip of the constant force spring, mounted at the rear and inside the outer tube, is clamped near the base of the enclosure 301 with a small clamping plate 305. A reinforcing plate 306, mounted under the inner sliding tube below the clamping device, serves also as a stopper to the moving sliding tubes (after unclamping the part) when contacting the extremity of the outer tube 312. It also serves as a mounting plate for torsion springs 308 located on both sides of the clamp 304. These springs, combined with a simultaneous vacuum applied inside the diaphragm 302, are used to unclamp the composite sheet 307 by rotation of the clamp 304 inside the enclosure 301. Similar to the first embodiment shown in FIG. 6, a free space 309, located in front of the constant force spring 311 and inside the outer tube 312, can be used to mount a braking system for the steel strip of the constant force spring in order to increase the membrane force on the composite sheet 307.

Operation of the system involves application of a vacuum inside the diaphragm 302 via the flexible tubing 303. The deflation of the diaphragm 302, combined with the action of the torsion springs 308 forces the L-shaped clamp 304 to open. The composite sheet in then installed over the supports arrangement, in similar fashion as shown in FIG. 5. Once the composite sheet is in place, the vacuum inside the diaphragm 302 is pressurized, to rotate the clamp 304 and clamp the composite sheet. The press support frame is then moved into the oven for the melting of the composite sheet. To avoid damaging the clamping support, air inlet tubing 303 must be made of a flexible steel pneumatic cable. Also, the cylindrical enclosure 301 can be made of aluminium or steel in order to avoid damages to the diaphragm by the infrared heating system of the oven. During molding, the constant force spring applies a membrane force on the composite sheet 307, similar to the system of FIG. 6. Once the part is formed, the pressure inside the diaphragm is relieved to a vacuum to unclamp the part. Once unclamped, the constant force spring forces the sliding tubes to enter one into the other, placing the clamps near the sides of the press frame, ready to begin another molding cycle.

The main advantage of this system is its compactness, allowing the maximum space inside the press frame to support a maximum size composite sheet. The excess space over and under the press frame taken by the clamping system is also minimized, thus minimizing any obstruction of the support with the surrounding equipments and the tooling. This advantage is important since material lost is minimized.

It will be understood that the invention may be used with any thermoformable material sheet and that the continuous fibre reinforced thermoplastic is illustrated herein only as an example. The present invention is not limited to the sole embodiment described above, but encompasses any and all embodiments within the scope of the following claims.

I claim:

1. A method of molding a thermoformable sheet material having opposed sides, comprising:
providing a mold having a first section and a second section, said first section including a compliant mold member, said second section including a rigid mold base configured to releasably receive said first section;
providing a selectively pressurizable diaphragm in said first section for coaction with said compliant mold member;
positioning said sheet material between said first section and said second section and closing said mold; and
pressurizing said diaphragm to urge said compliant member against said sheet to mold said sheet into a shape of said second section.

2. The method as set forth in claim 1, further including the step of preheating said sheet material prior to molding.

3. The method as set forth in claim 1, wherein the step of pressurizing comprises negative pressurization during a molding phase.

4. The method as set forth in claim 1, wherein the step of pressurizing comprises positive pressurization during a removal phase where a molded article is removed from said mold.

5. The method as set forth in claim 1, wherein said method further includes the step of cooling molded sheet material.

6. The method as set forth in claim 1, wherein said cooling of said sheet material occurs within said second section.

7. The method as set forth in claim 1, wherein said method includes the step of adjusting sheet material tension during molding to prevent inconsistencies in the molded sheet.

8. The method as set forth in claim 7, wherein said method includes the step of adjusting sheet material tension in a plurality of directions.

9. A method of molding a thermoformable sheet material having opposed sides, comprising:
providing a mold having a first section and a second section, said first section including a compliant mold member, said second section including a rigid mold base configured to releasably receive said first section;
providing a selectively pressurizable diaphragm in said first section for coaction with said compliant mold member;
positioning said sheet material between said first section and said second section and closing said mold;
adjusting sheet material tension during molding to prevent inconsistencies in the molded sheet; and
pressurizing said diaphragm to urge said compliant member against said sheet to mold said sheet into a shape of said second section.

10. The method as set forth in claim 9, wherein said method includes the step of adjusting sheet material tension in a plurality of directions.

11. The method as set forth in claim 10, wherein said adjusting is dynamic during said molding.

12. The method as set forth in claim 9, wherein said pressurizing includes negative pressurization during molding and positive pressurization at completion of said molding to release contact between said diaphragm from said compliant member.

13. A method of molding a thermoformable sheet material having opposed sides, comprising:
providing a mold having a first section and a second section, said first section including a compliant mold member and a selectively pressurizable diaphragm, said second section including a rigid mold base configured to releasably receive said first section;
positioning said thermoformable sheet material between said first section and said second section;
stamping said first section into said second section;
compressing, by pressurization of said diaphragm, said compliant member to urge said sheet material against said rigid mold base whereby said sheet material is uniformly dimensioned throughout its molded shape; and
depressurizing said mold to release said molded shape.

14. The method as set forth in claim 13, including repositioning said sheet material relative to said mold during molding to ensure uniform pressurization of said sheet material.

15. The method as set forth in claim 13, including cooling said mold during molding.

16. A method of supporting and adjusting the movement of sheet material during a sheet molding operation, comprising:
providing sheet material to be molded;
providing a frame having a plurality of selectively movable clamp members;
clamping said sheet material with said clamp member;
effecting a molding operation during which said sheet material is exposed to irregular forces; and
selectively operating said clamping members to allow movement and adjustment of said sheet material during exposure to said forces.

17. The method as set forth in claim 16, further including the step of rotating said clamping members about a vertical axis and a horizontal axis relative to said frame.

18. The method as set forth in claim 16, further including the step of moving said clamp members in translation relative to said frame.

19. An apparatus for supporting and adjusting the movement of sheet material during a sheet molding operation, comprising:
a frame
a plurality of selectively movable clamp means for clamping said sheet material;
means for effecting translational movement of said clamping members relative to said frame for adjustment of said sheet material relative to said frame during exposure to forces encountered in said molding operation; and
means for effecting rotational movement of said clamping members about a vertical and a horizontal axis relative to said frame, whereby said sheet material is dynamically adjusted in a plurality of directions during molding.

20. The apparatus a set forth in claim 19, wherein said clamping members are independently operable.

21. The apparatus a set forth in claim 19, further including stop means for stopping translational movement of said clamping members.

22. The apparatus a set forth in claim 19, further including tensioning means for adjusting tension in said clamping members.

23. The apparatus a set forth in claim 19, wherein said means for effecting translational movement of said clamping members includes telescopically adjustable tubes.

24. A product molded in accordance with the method of claim 1, said product including a plurality of surface finishes with a transition between said finishes.

25. The product as set forth in claim 24, wherein said transition between said finishes comprises a line of demarcation between and dividing each surface finish.

26. An apparatus for molding a thermoformable sheet material having opposed sides, comprising:
a mold having a first section and a second section, said first section including a compliant mold member, said second section including a rigid mold base configured to releasably receive said first section, said first section and said second section forming a mold volume when in contact;
a selectively pressurizable diaphragm in said first section for coaction with said compliant mold member and operable within said mold volume; and
means for pressurizing said mold volume to move said diaphragm whereby said sheet material is uniformly dimensioned throughout its molded shape.

27. The apparatus as set forth in claim 26, wherein said means for pressurizing said mold volume comprises a plurality of conduits positioned within said first section.

28. The apparatus as set forth in claim 26, wherein said diaphragm comprises a resilient elastomeric membrane.

29. The apparatus as set forth in claim 26, wherein said first section of said mold includes a rigid mounting member for mounting said compliant member and said diaphragm.

30. The apparatus as set forth in claim 26, further including repositioning means.

31. The apparatus as set forth in claim 26, wherein said repositioning means comprises a plurality of discrete clamp members for retaining said sheet material and facilitating dynamic movement thereof during molding.

32. The apparatus as set forth in claim 26, wherein said plurality of discrete clamp members are independently operable.
